(19) United States
(12) Patent Application Publication
(10) Pub. No.: US 2006/0102290 A1
(43) Pub. Date: May 18, 2006

(54) Wafer support plate, holding method of thin wafer, and manufacturing method of semiconductor device

(76) Inventors: Susumu Harada, Yokohama-shi (JP); Chiaki Takubo, Tokyo (JP); Kenji Takahashi, Tsukuba-shi (JP); Hideo Aoki, Yokohama-shi (JP); Hideo Numata, Yokohama-shi (JP); Hisashi Kaneko, Fujisawa-shi (JP); Hirokazu Ezawa, Tokyo (JP); Mie Matsuo, Kamakura-shi (JP); Hiroshi Ikenoue, Nankoku-shi (JP); Ichiro Omura, Yokohama (JP)

Correspondence Address: FINNEGAN, HENDERSON, FARABOW, GARRETT & DUNNER;LLP, 901 NEW YORK AVENUE, NW, WASHINGTON, DC, 20001-4413, US

(21) Appl. No.: 11/221,763

(22) Filed: Sep. 9, 2005

(30) Foreign Application Priority Data
Sep. 10, 2004 (JP) P2004-264730
Sep. 17, 2004 (JP) P2004-272518

(51) Int. Cl. B32B 37/00

(52) U.S. Cl. 156/349

(57) ABSTRACT

A wafer supporting plate is formed of a glass or a resin which can permeate ultraviolet rays and has a nearly disk shape. An outer diameter of the wafer supporting plate is larger than that of the semiconductor wafer which is supported. In the wafer supporting plate, a plurality of openings are formed to correspond to plural through holes of the semiconductor wafer. The opening has an open area larger than an open area of the through hole, that is, has a larger diameter.

### CROSS-REFERENCE TO RELATED APPLICATION

This application is based upon and claims the benefit of priority from the prior Japanese Patent Application No. 2004-264730, filed on Sep. 10, 2004; and the prior Japanese Patent Application No. 2004-272518, filed on September 17; the entire contents of which are incorporated herein by reference.

### BACKGROUND OF THE INVENTION

1. Field of the Invention

The invention relates to a wafer support plate used in manufacturing process comprising the steps of forming a through hole in a semiconductor wafer and drawing out an electrode on an element mounting surface to a rear surface of the semiconductor wafer, a holding method of a thin wafer and a manufacturing method of a semiconductor device.

2. Description of the Related Art

Heretofore, to miniaturize a semiconductor device, it is known that a plurality of semiconductor chips is disposed on a substrate to constitute a multi-chip type semiconductor device. And it is known to form a through hole passing through the semiconductor chip, to coat a conductor on an inside of the through hole by plating so as to form a connecting plug electrically connecting between the front and rear surfaces of the semiconductor chip, and to connect to other semiconductor chip using the connecting plug so as to form a semiconductor device of which the semiconductor chips are stacked (for example, refer to Japanese Patent Laid-open Application No. Hei 10-223833).

When manufacturing a semiconductor device by processing the semiconductor wafer having a through hole mentioned above, it is considered to process in a state of supporting the semiconductor wafer using a wafer supporting plate.

As a conventional manufacturing method of the semiconductor device using the wafer supporting plate mentioned above, in order to grind the rear surface of extremely thin semiconductor wafer (100 μm or less), a method of supporting the semiconductor wafer using a wafer supporting plate and processing the semiconductor wafer is known. That is, at the time of grinding the rear surface of the semiconductor wafer, the semiconductor wafer is fixed on a wafer supporting plate made of plate shaped glass with an adhesive of which adhesive characteristics is deteriorated when irradiating ultraviolet rays between the wafer and the supporting plate. And when separating the semiconductor wafer from the wafer supporting plate after grinding the rear surface, it is also possible to separate by irradiating ultraviolet rays through the wafer supporting plate.

If the processing of the semiconductor wafer having a through hole is carried out by using the above wafer supporting plate, one side of through hole to form a through electrode is closed with the wafer supporting plate and the adhesive. Accordingly, when plating the through hole portion, a plating liquid can not be satisfactorily circulated in the through hole, thereby the forming of uniform plating being prevented.

Further, there is another method which uses a wafer supporting plate for grinding the rear surface of extremely thin semiconductor wafer (100 μm or less). In this method, a semiconductor wafer is stuck with a stuck on a wafer supporting plate of which many small holes (for example, about 0.5 mmφ) are provided, and after grinding the rear surface and penetrating a solution which dissolves the adhesive through the small holes to decrease the bonding strength, the semiconductor wafer is separated from the wafer supporting plate.

When a semiconductor wafer having a through hole is processed by using the above wafer supporting plate, in case that the through hole of the semiconductor wafer is closed at a region not having a small hole of the wafer supporting plate, one side of the through hole is closed. Therefore, there is a problem that a plating liquid can not be circulated in the through hole, hence the forming of uniform plating can not be achieved. Even if the through hole of the semiconductor wafer corresponds to the small hole of the wafer supporting plate, there arises a problem that a solution for dissolving an adhesive is flowed out through the through hole, and can not fully spread into the adhesive, thereby the bonding therebetween being difficult due to the decrease of adhesiveness.

Further, as a method of transporting, processing and other operating of a thinner (for example, thickness of 100 μm or less) semiconductor wafer (hereafter, refer to as a thin wafer), a method of suppressing the break down thereof by sticking a holding material such as a sheet formed of cloth or fiber or a glass substrate on a rear surface or a front surface of the thin wafer is known. For example, a method of sticking an adhesive sheet for dicing on a rear surface of the thin wafer through a reinforcement sheet, and fixing the thin wafer to a ring frame through the adhesive sheet for dicing is known (for example, Japanese Patent Laid-open Application No. 2003-332267).

However, in a process for a three-dimensional mounting of chip, not only to one surface side of the thin wafer, but also to both surface sides, the process of forming a wiring, connecting between the front surface and the rear surface and the like is necessary. When such working process to the both surfaces is carried out, the holding material being on the front surface or rear surface of the thin wafer complicates the process and increase number of steps. Further, whenever the working steps on both front and rear surfaces are carried out, the change of sticking of holding material is necessary. Accordingly, the cost of process is increased and the possibility of break down of the wafer is also increased to decrease the yield thereof.

### SUMMARY OF THE INVENTION

According to an aspect of the present invention, there is provided a wafer supporting plate for supporting a semiconductor wafer thereon, the semiconductor wafer comprising a through hole passing through front and rear surfaces thereof, an electrode formed on the front surface of the semiconductor wafer and extended to the rear surface of the semiconductor wafer, wherein the wafer supporting plate has an opening passing through between a front surface and rear surface of the wafer supporting plate, the opening being disposed to face a region including at least one or more of the through hole of the semiconductor wafer and a cross sectional area of the opening being larger than that of the through hole of the semiconductor wafer.

Further, according to an aspect of the present invention, there is provided a wafer supporting plate for supporting a semiconductor wafer thereon, the semiconductor wafer comprising a through hole passing through front and rear surfaces thereof, an electrode formed on the front surface of the semiconductor wafer and extended to the rear surface of the semiconductor wafer, wherein the wafer supporting plate has a recess portion at a side of supporting the semiconductor wafer, the recess portion being disposed to face a region including at least one or more of the through hole of the semiconductor wafer and an opening area of the recess portion being larger than a cross sectional area of the through hole of the semiconductor wafer.

Further, according to an aspect of the present invention, there is provided a method of holding a thin wafer to a holding member comprising, bonding the thin wafer to the holding member through an adhesive layer provided along a periphery of the thin wafer, and fixing the thin wafer to the holding member, wherein at least one of the holding member and the adhesive layer has an opening communicated to a space between the thin wafer and the holding member.

### BRIEF DESCRIPTION OF THE DRAWINGS

FIG. 1 is a view showing a structure of a wafer supporting plate according to a first embodiment of the invention.

FIG. 2 is an enlarged view of a cross sectional structure of an essential part of the wafer supporting plate shown in FIG. 1.

FIG. 3 is a view showing a structure of a wafer supporting plate according to a second embodiment of the invention.

FIG. 4 is an enlarged view of a cross sectional structure of an essential part of the wafer supporting plate shown in FIG. 3.

FIG. 5A, FIG. 5B, FIG. 5C and FIG. 5D are views showing an embodiment of manufacturing method of the invention.

FIG. 6A, FIG. 6B and FIG. 6C are views showing other embodiment of manufacturing method of the invention.

FIG. 7 is a view showing a structure of other embodiment of manufacturing method of the invention.

FIG. 8 is a view showing a structure of other embodiment of manufacturing method of the invention.

FIG. 9A, FIG. 9B, FIG. 9C and FIG. 9D are views showing a structure of other embodiment of manufacturing method of the invention.

FIG. 10A, FIG. 10B and FIG. 10C are views showing other embodiment of manufacturing method of the invention.

FIG. 11 is a view showing other embodiment of manufacturing method of the invention.

FIG. 12 is a view showing other embodiment of manufacturing method of the invention.

FIG. 13A, FIG. 13B, FIG. 13C, FIG. 13D and FIG. 13E are schematic views of a holding process of a thin wafer according to a third embodiment of the invention.

FIG. 14 is a schematic plan view showing a holding member fixing a thin wafer according to a third embodiment of the invention.

FIG. 15 is a schematic plan view showing a holding member of which a thin wafer is in a fixed state according to a third embodiment of the invention.

FIG. 16 is an enlarged view in the neighbor of a terminal portion at a side of adhesive layer of a holding member according to a third embodiment of the invention.

FIG. 17A and FIG. 17B are schematic views showing a state of which a thin wafer fixed to a holding member is fixed to a stage according to a third embodiment of the invention.

FIG. 18A, FIG. 18B, FIG. 18C, FIG. 18D and FIG. 18E are schematic views showing a state of which treatments are carried to a thin wafer fixed to a holding member according to a third embodiment of the invention.

FIG. 19 is a schematic vertical cross sectional view showing a thin wafer according to a third embodiment of the invention.

FIG. 20A and FIG. 20B are respectively a schematic vertical cross sectional view and a schematic plan view showing a holding member in a state of which a thin wafer is fixed according to a fourth embodiment of the invention.

FIG. 21A and FIG. 21B are respectively a schematic vertical cross sectional view and a schematic plan view showing a holding member in a state of which a thin wafer is fixed according to a fifth embodiment of the invention.

FIG. 22A and FIG. 22B are respectively a schematic vertical cross sectional view and a schematic plan view showing a holding member in a state of which a thin wafer is fixed according to another fifth embodiment of the invention.

FIG. 23A and FIG. 23B are respectively a schematic vertical cross sectional view and a schematic plan view showing a holding member in a state of which a thin wafer is fixed according to a sixth embodiment of the invention.

FIG. 24A, FIG. 24B, FIG. 24C, and FIG. 24D are schematic views showing a holding process of a thin wafer according to the seventh embodiment of the invention.

FIG. 25A, FIG. 25B, FIG. 25C, and FIG. 25D are schematic views showing a holding process of a thin film wafer according to the eighth embodiment of the invention.

FIG. 26A is a schematic view showing a state of which metal plating is filled in a through hole of a conventional thin wafer, and FIG. 26B is a schematic view showing a state of which metal plating is filled in a through hole of a conventional thin wafer, and thereafter a holding member is separated from the wafer.

### DESCRIPTION OF THE EMBODIMENTS

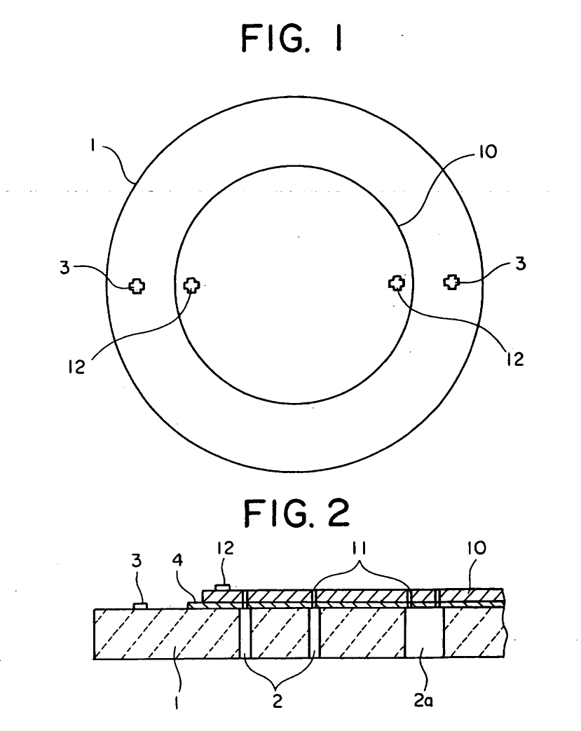

Hereinafter, embodiments of the present invention will be explained referring to the drawings. FIGS. 1 and 2 are schematic views showing a structure of a wafer supporting plate according to a first embodiment of the invention. As shown in FIG. 1, a wafer supporting plate 1 is formed of a glass or resin which is possible to penetrate ultraviolet rays, nearly in a shape of disk. The diameter of the disk is larger than that of a semiconductor wafer supported.

As shown in FIG. 2, in the wafer supporting plate 1, a plurality of openings 2 are formed to correspond to a plurality of through holes 11. These openings are allowed to dispose in the following way that, as shown at left side in FIG. 2, one opening 2 corresponds to one through hole 11, or as shown at right side in FIG. 2, one opening 2 corresponds to plural through holes 11. The opening 2 corresponding to one through hole 11 has an open area larger than an open area of the through hole 11, that is, the open diameter of the opening 2 is set to be larger than that of the through hole 11.

Further, in the wafer supporting plate 1, plural alignment marks 3 for aligning are formed (in the embodiment two marks). By aligning the aligning mark 3 with an aligning mark 12 formed on the semiconductor wafer 10, the semiconductor wafer 10 can be stuck on a predetermined position of the wafer supporting plate 1. By providing the marks 3 for aligning on the wafer supporting plate 1, the accuracy of sticking of the semiconductor wafer 10 can be improved so as to enable to carry out a fine operation. In addition, at the time of processing of an opening 2 to be provided in the wafer supporting plate 1, the alignment marks 3 can be similarly processed, thereby the accuracy of position between the opening 2 and the alignment mark 3 being improved.

Reference No. 4 in FIG. 2 denotes an adhesive for sticking the semiconductor wafer 10 on the wafer supporting plate 1. The adhesiveness of the adhesive 4 with the semiconductor wafer 10 is decreased by irradiating ultraviolet, thereby the semiconductor wafer 10 being separated from the wafer supporting plate 1.

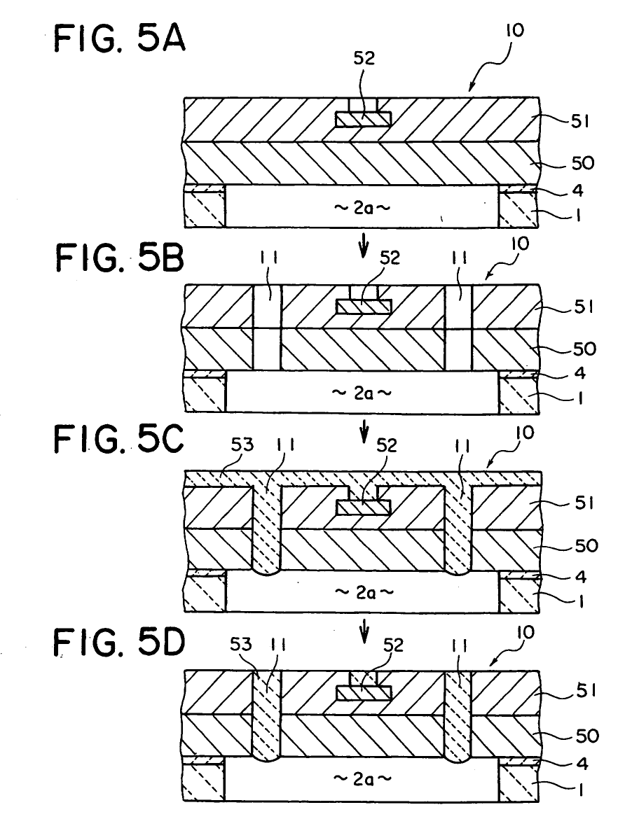

The above wafer supporting plate 1 can be used in case of laser beam machining for forming a through hole 11 in the semiconductor wafer 10, or in case of plating in the through hole 11 or the like. FIGS. 5A, 5B, 5C and 5D show an embodiment for manufacturing method of a semiconductor device using the wafer supporting plate 1. In FIG. 5, reference No. 50 denotes silicon constituting the semiconductor wafer 10, No. 51 denotes a layer insulation film or a protective film, and No. 52 denotes an electrode at an element mounting surface side (front surface side).

In the process shown in FIG. 5A, on a rear surface side of the semiconductor wafer 10, the wafer supporting plate 1 is stuck. At this time, by aligning the mark 3 for alignment formed on the wafer supporting plate 1 with the mark 12 for alignment formed on the semiconductor wafer 10, the semiconductor wafer 10 is stuck on a predetermined position of the wafer supporting plate 1.

In the process shown in FIG. 5B, the through hole 11 is formed in a predetermined position of the semiconductor wafer 10, by laser beam machining and the like. The process of forming the through hole 11 was conventionally carried out by sticking to a dicing tape. Compared with the use of the dicing tape, a method of the present embodiment has effects that the adhesion of dusts of the dicing tape produced by the laser beam machining to the through hole 11 can be prevented, and the laser beam machining can be carried out from the both surface sides. FIGS. 5B to 5D shows a case that one opening 2a is formed to plural through holes.

FIG. 5C shows a process that the through holes 11 are filled with an insulation resin (polyimide resin and the like), and FIG. 5D illustrate a process that an insulation resin 53 at the front surface side is polished. In these processes, the processing can be carried out in a state that the semiconductor wafer 10 is supported with the wafer supporting plate 1.

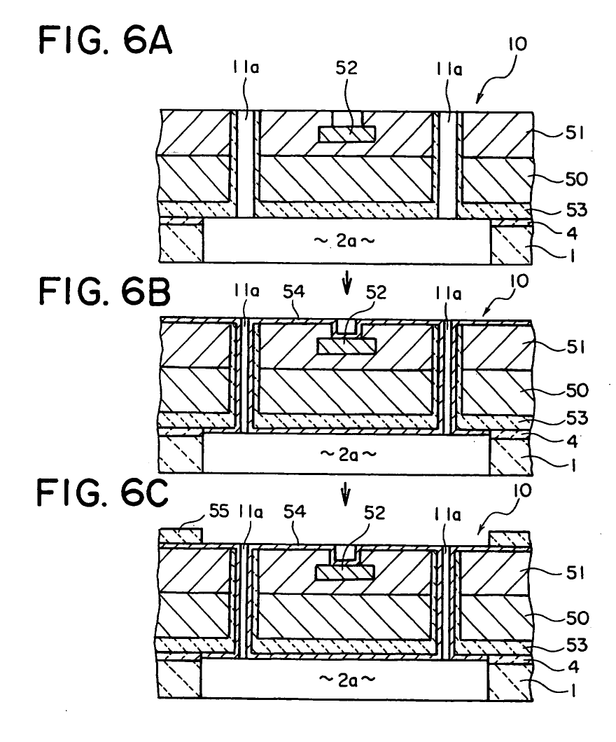

After the above processes, an insulation resin (polyimide and the like) 53 is coated by spin-coating method and the like on the rear surface of the semiconductor wafer 10, and thereafter, as shown in FIG. 6A, a fine through hole 11a is formed at the center portion of the insulation resin 53 filled the through hole 11 to remain the insulation resin 53 at the inside wall surface of the through hole 11. In this process, the processing can also be carried out in a state that the semiconductor wafer 10 is supported with the wafer supporting plate 1.

When such processes are conducted, if a wafer supporting plate not having an opening portion is used, the wafer supporting plate is deteriorated due to heat produced by the processing of insulation resin, and dusts produced at the time of laser beam machining are deposited in a bottom portion, thereby the fine operations become difficult. In contrast, in the present embodiment of the invention, it is possible to prevent the occurrence of above problems owing to the opening 2. In addition, it becomes possible to conduct the laser beam machining from the both surface sides of the semiconductor wafer 10, thereby uniform processing being realized.

Subsequently, as shown in FIG. 6B, in a state of supporting the semiconductor wafer 10 with the wafer supporting plate 1, a seed layer 54 is formed by electro-less plating method. In this process of plating of seed, if using a wafer supporting plate not having an opening portion, a plating liquid can not uniformly be circulated in the small through hole 11a, thereby a uniform plating being difficult. In contrast, in the present embodiment of the invention, the circulation of a plating liquid can be better owing to the opening 2, thereby uniform plating even to a fine through hole 11a being carried out.

FIG. 6C shows the forming process of resist layer 55 subsequently carried out. Also this process can be carried out in a state of supporting the semiconductor wafer with the wafer supporting plate 1.

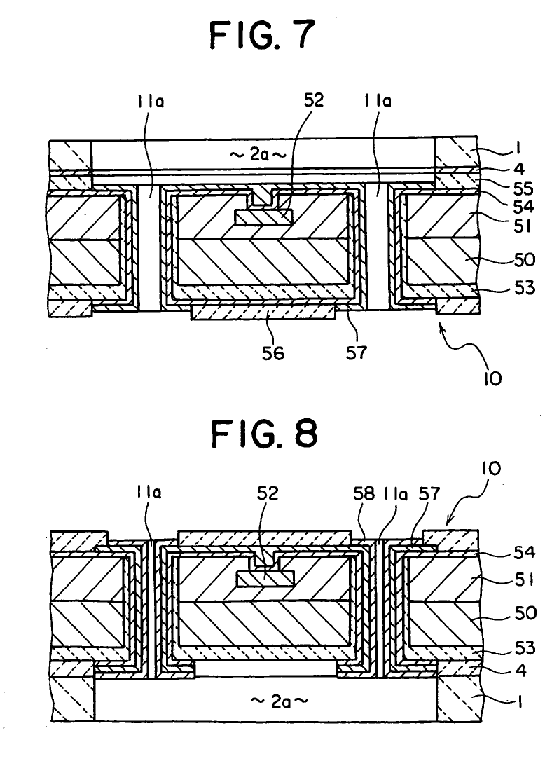

FIG. 7 shows the process of forming a copper wiring layer 57 on the seed layer 54 mentioned above by using an electrolysis plating method and using the resist layer 56 as a mask. In the process, it is possible to implement the plating in a state of sticking the wafer supporting plate 1 on a front surface side of the semiconductor wafer 10. Further, FIG. 8 shows the process of forming a Ni/Au plating layer 58 using the electro-less Ni/Au plating. In the process, it is possible to carry out the plating operation in a state that the wafer supporting plate 1 is stuck on the rear surface side of the semiconductor wafer 10. Also in this plating process, by using the wafer supporting plate 1, minute and uniform plating can be given to the fine through hole 11a.

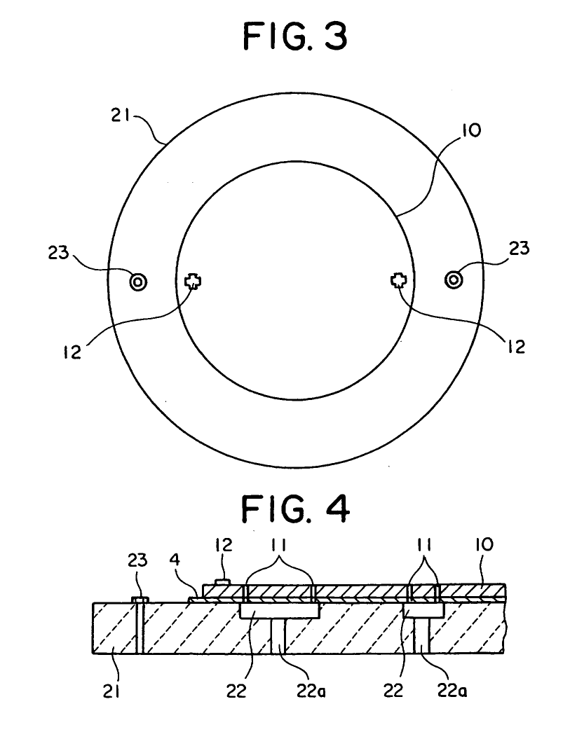

FIGS. 3 and 4 are schematic views showing a structure of a wafer supporting plate according to a second embodiment of the invention. In the corresponding portion as FIGS. 1 and 2, the same numbers are affixed. As shown in FIG. 3, a wafer supporting plat 21 is formed of glass or resin having permeability to ultraviolet rays and has almost a disk shape. The diameter of disk is larger than that of the semiconductor wafer 10 being supported thereon.

As shown in FIG. 4, the wafer supporting plate 21 has a plurality of recess portions 22 on a surface at the side supporting the semiconductor wafer to correspond to a plurality of through holes formed in the semiconductor wafer 10. These recess portions 22 are formed in a region including at least one through hole 11. Even in case of one through hole 11, an opening area of the recess portion 22 is larger than the open area of the through hole 11. Further, in the recess portion 22, a through hole portion 22a such that a portion thereof passes through the wafer supporting plate 21 to a rear surface 21 thereof.

The wafer supporting plate 21 of the second embodiment is also used in the manufacturing method of the semiconductor device like as the wafer supporting plate 1 of the first embodiment.

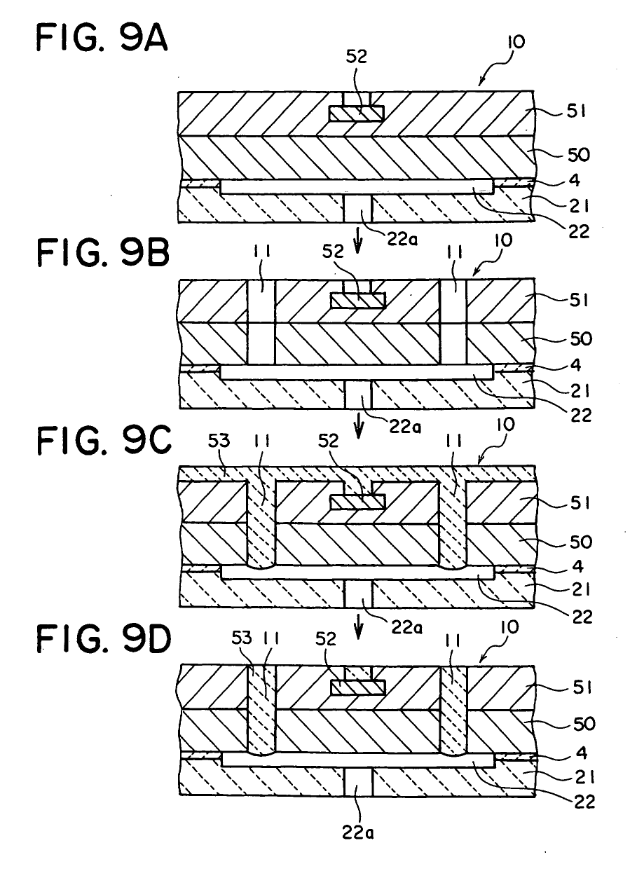

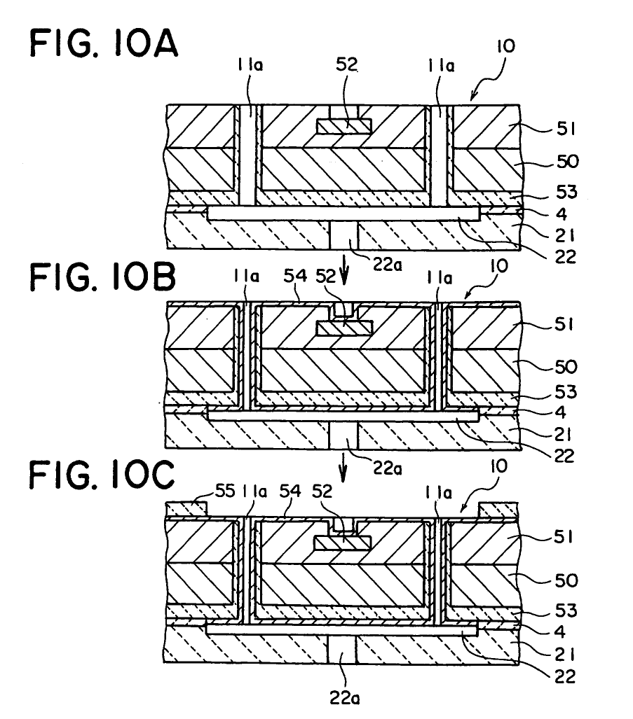

FIGS. 9A to 9D shows an example implemented according to the manufacturing process of the semiconductor device shown in FIGS. 5A to 5D. Here, portions corresponding to those in FIGS. 5A to 5D have the same numbers. In the process shown FIG. 9A, on a rear surface of a semiconductor wafer 10, a wafer supporting plate 21 is stuck with an adhesive 4. At this time, by aligning the marks 23 for alignment formed on the wafer supporting plate 21 with the marks 12 for alignment formed in the semiconductor wafer 10, the semiconductor wafer 10 can be stuck on a predetermined position on the wafer supporting plate 21.

Subsequently, as shown in FIG. 9B, a through hole 11 is formed in a predetermined position of the semiconductor wafer 10 by laser beam machining and the like. Thereby, as in case of using a dicing tape, the adhesion of dusts of the dicing tape produced by the laser beam machining and the like to the through hole 11 can be prevented.

FIG. 9C shows a process of filling the through hole 11 with an insulation resin (polyimide resin and the like) 53. FIG. 9D shows a process of polishing the insulation resin 53 at a front surface side. In these processes, it is possible to process in a state of supporting the semiconductor wafer 10 with the wafer supporting plate 21.

After the above processes, an insulation resin (polyimide and the like) 53 is coated by spin-coating method and the like on the rear surface of the semiconductor wafer 10, and thereafter, as shown in FIG. 1A, a fine through hole 1a is formed at the center portion of the insulation resin 53 filled the through hole 11 to remain the insulation resin 53 at the inside wall surface of the through hole 11. In this process, the processing can also be carried out in a state that the semiconductor wafer 10 is supported with the wafer supporting plate 21.

At the time of implementing the above process, when a wafer supporting plate not having an opening portion is used, the wafer supporting plate is deteriorated due to heat produced by the processing of insulation resin, and dusts produced at the time of laser beam machining are deposited in a bottom portion, thereby the fine operations become difficult. In contrast, in the present embodiment of the invention, it is possible to prevent the occurrence of above problems owing to the recess 22 and the through hole portion 22a.

Subsequently, as shown in FIG. 10B, in a state of supporting the semiconductor wafer 10 with the wafer supporting plate 21, a seed layer 54 is formed by electro-less plating method. In this process of plating of seed, if using a wafer supporting plate not having an opening portion, a plating liquid can not uniformly be circulated in the through hole 11a, thereby a uniform plating being difficult. In contrast, in the present embodiment of the invention, the circulation of a plating liquid can be better owing to the recess portion 22 and the through hole 22a, thereby uniform plating even to a fine through hole 11a being carried out.

FIG. 10C shows a forming process of a resist layer 55 subsequently carried out. In this process, it is possible to implement in a state of supporting the semiconductor wafer with the wafer supporting plate 21.

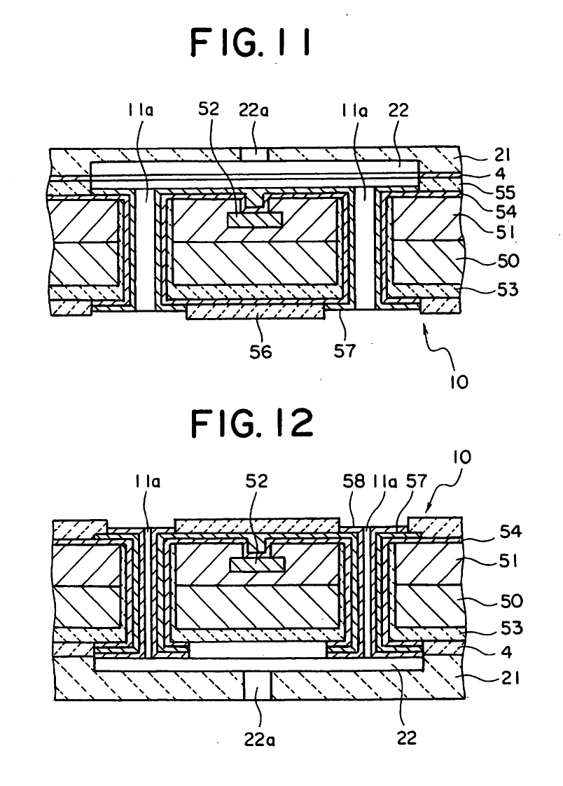

FIG. 11 shows a process of forming a copper wiring layer 57 on the seed layer 54 mentioned above by using an electrolysis plating method and using the resist layer 56 as a mask. In the process, it is possible to implement the plating in a state of sticking the wafer supporting plate 21 on a front surface side of the semiconductor wafer 10. Further, FIG. 12 shows the process of forming a Ni/Au plating layer 58 using the electro-less Ni/Au plating. In the process, it is possible to implement the plating operation in a state that the wafer supporting plate 21 is stuck on the rear surface side of the semiconductor wafer 10. Also in this plating process, by using the wafer supporting plate 21, minute and uniform plating can be given to the fine through hole 11a.

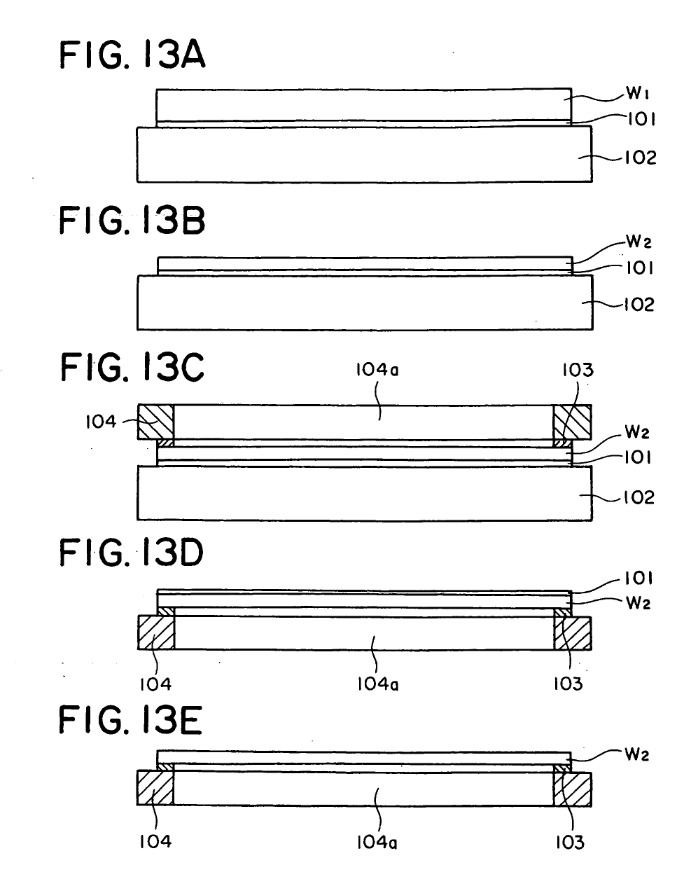

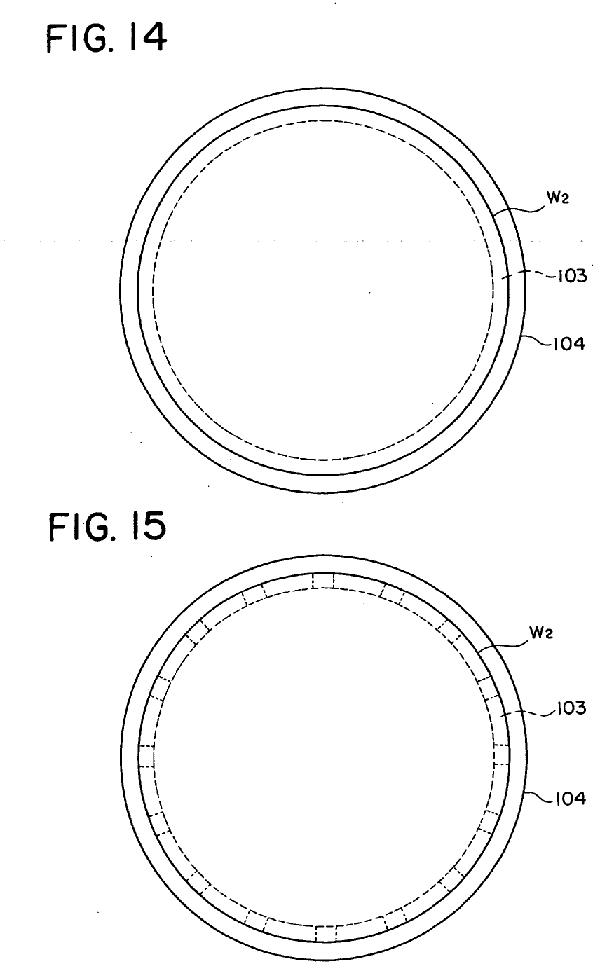

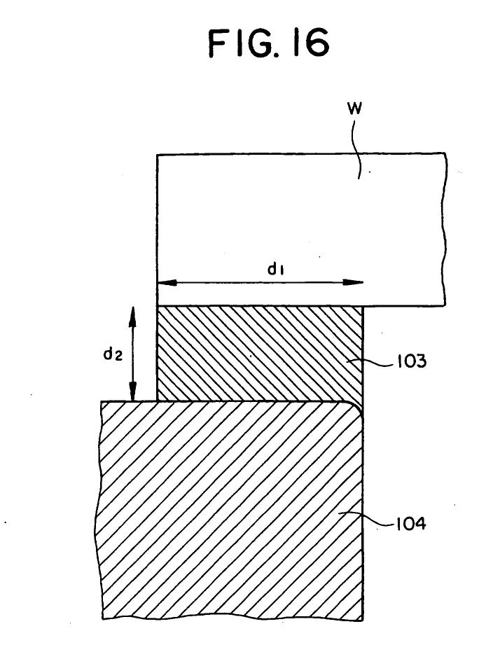

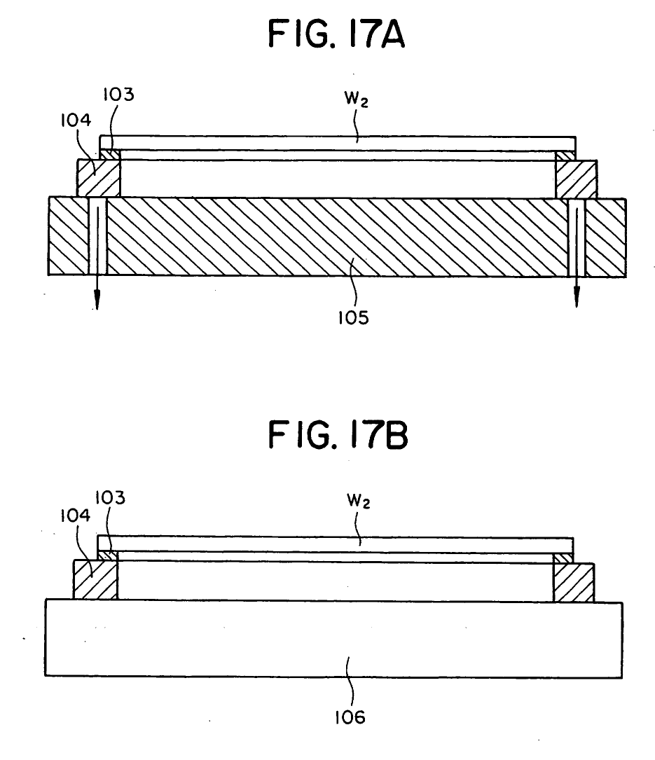

Hereinafter, a holding method of a thin wafer according to a third embodiments of the present invention will be explained. FIG. 13A to FIG. 13E show schematic views showing a wafer thinner process and a thin wafer holding process according to the third embodiment of the invention. FIG. 14 and FIG. 15 are respectively schematic plan views showing a holding member in a fixed state of a thin wafer according to the third embodiment of the invention. FIG. 16 is an enlarged view in the neighborhood of a terminal portion at an adhesive side of a holding member according to the present embodiment. FIG. 17A and FIG. 17B are schematic views showing a state of fixing a holding member, on which a thin wafer is fixed, to a stage according to the embodiment of the invention.

As shown in FIG. 13A, first, a protective film 101 is formed on a surface (at device side) of a wafer W1 of Si, and the wafer W1 is fixed to a stage 102 through the protective film 101 by a vacuum chuck.

Next, the rear surface of the wafer W1 is subjected to a mechanical grind. Thereafter, to improve the mechanical strength of the wafer W1 and to remove a damage such as a crystal defect, the process such as dry polishing, chemical mechanical polishing (CMP), wet etching and dry etching is implemented. Thereby, as shown in FIG. 13B, the wafer W1 is processed to be thinner. (hereafter, a wafer to be thinner is called as “a thin wafer”). A thickness of the thin wafer W₂ is about 200 μm or less, preferably, about 100 μm or less.

Thereafter, as shown in FIG. 13C, a holding member 104 is attached to the rear surface of the thin wafer W₂ through an adhesive layer 103. As shown in FIG. 13C and FIG. 14, the holding member 104 has a ring shape. Therefore, in the holding member 104, an opening 104a communicated to a space between the thin wafer W₂ and the holding member 104 is formed. The opening 104a is used, for example, to contact a fluid such as chemical liquid or gas for treating the thin wafer W₂ through opening 104a, or, when a through hole passing through the thin wafer W₂ is formed in the thin wafer W₂, to flow out the chemical liquid or gas, which is flowed in through the through hole from the front side of the thin wafer W₂, to the rear surface side of the thin wafer W₂, and the like.

The holding member 104 is desirable to be formed of a material having a corrosion resistance to the chemical liquid or gas used for treating the thin wafer W₂. Instead of forming the holding member 104 with such material or together with a holding member formed of such material, a holding member 104 coated with a corrosion resistant material to the fluid such as a chemical liquid or gas can be used. The holding member 104 can be constituted of, for example, a single crystal Si or an Fe alloy having a ferrite layer (SUS 310S).

The holding member 104, for example, having an inner diameter of 196 mm, an outer diameter of 204 mm and a thickness of 1 mm can be used, although its size varies depending on the size of the thin wafer W₂. An inner peripheral surface and an end portion of the thin wafer W₂ are chamfered, as shown in FIG. 16.

An adhesive layer 103 is provided along the outer periphery of the thin wafer W₂, and the thin wafer W₂ is bonded to the adhesive layer 103 at the outer peripheral portion of the thin wafer W₂. In the present embodiment, the adhesive layer 103 is provided in a ring shape. However, the adhesive layer 103 is allowed if it is provided along the outer periphery of the thin wafer W₂, even if the adhesive layer has not the ring shape. For example, as shown in FIG. 15, the adhesive layer 103 may be constituted of divided plural adhesive layers 103. In this case, an opening is formed between the plural adhesive layers 103.

As shown in FIG. 16, a length d1 of the adhesive layer 103 in a direction vertical to the periphery of the thin wafer W₂ is larger than a length d2 of the adhesive layer 103 in a thickness direction. The surface roughness on the rear surface of the thin wafer W₂ is one-fourth or les the thickness of the adhesive layer 103.

Thereafter, the holding by the vacuum chuck is released. Then, as shown in FIG. 13D, the thin wafer W₂ is fixed to the holding member 104, and the thin wafer W₂ is held on the holding member 104. Finally, as shown in FIG. 13E, the protective film 101 is removed.

In addition, it is possible to fix the holding member 104, on which the thin wafer W₂ is fixed, to a stage 105 and the like by using a vacuum chuck, as shown in FIG. 17A. Further, when the holding member 104 is constituted of a magnetic material, as shown in FIG. 17B, the thin wafer W₂ can be also fixed by magnetic force on a stage 105 constituted of an electromagnet or magnet using a tool, carrier or the like.

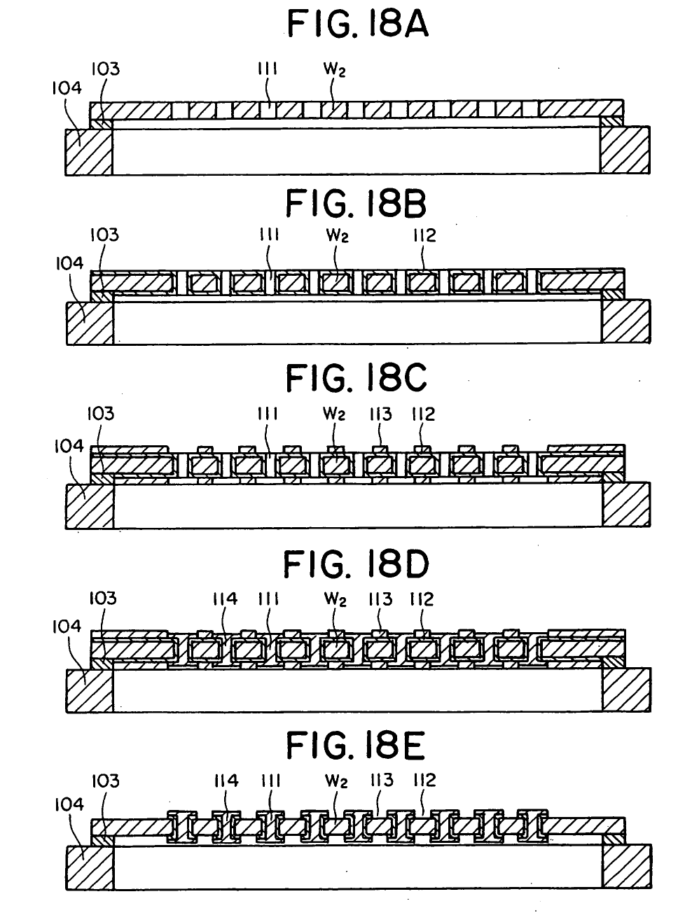

To the thin wafer W₂ being in a fixed state, for example, the following processes are implemented. FIG. 18A to FIG. 18E are schematic views showing the states of treating the thin wafer W₂ fixed on the holding member 104 according to the present embodiment. Here we will describe the thin wafer W₂ which has a through hole 111 passing through from the front surface to the rear surface thereof, and an insulation film (not shown) formed on the front and rear surfaces of the thin wafer W₂ and formed on an inside of the through hole 11.

As shown in FIG. 18A, according to the previous described method, the thin wafer W₂ is fixed to the holding member 104. Next, as shown in FIG. 18B, on the whole surface of the thin wafer W₂, a seed layer 112 constituting of, for example, a metal such as Ni by electro-less plating is formed. The electro-less plating can be conducted, for example, by dipping in a plating liquid, or by spraying the plating liquid from the both surfaces in an inactive atmosphere.

After forming the seed layer 112 on the thin wafer W₂, on the both surfaces of the thin wafer W₂, as shown in FIG. 18C, a resist 113 having a sheet shape is stuck, and the stuck resist is treated to form a pattern. Thereafter, as shown in FIG. 18D, a wiring layer 114, for example, constituted of a metal such as Cu and the like is formed by electrolysis plating on the seed layer 112. The wiring layer 114 is formed not only on the front and rear surfaces, but also in the through hole 111.

After forming the wiring layer 114, the resist 113 is removed, and the seed layer 112 being below the resist 113 is removed by etching. Then, a wiring is formed on the front surface and rear surface of the thin wafer W₂, as shown in FIG. 18E. A wiring formed on the front surface of the thin wafer W₂ and a wiring formed in the rear surface of the tin wafer W₂ are electrically connected with a wiring formed in the through hole.

In the present embodiment, on the holding member 104 having an opening 104a, the adhesive layer 103 is provided along an outer periphery of the thin wafer W₂. And, by bonding the adhesive layer 103 to the peripheral portion of the rear surface of the thin wafer W₂, the thin wafer W₂ is fixed to the holding member 104. Therefore, the thin wafer W₂ can be treated in the same way as a usual thick wafer. In the present embodiment, although the adhesive layer 103 is provided at the side of holding member, the adhesive layer 103 can be provided at the side of the thin wafer W₂. In this case, the same effects can be obtained similar with the case that the adhesive layer is provided at the side of the holding member 104.

Further, due to the above structure, in a state that the thin wafer W₂ is fixed to the holding member 104, it becomes possible to conduct on the rear surface of the thin wafer W₂. Thereby, the treatment to the both surfaces of the thin wafer W₂ can be conducted at one time, thereby the number of change of sticking process being decreased. Accordingly, the number of processes can be decreased.

Furthermore, since the treatment can be conducted on both surfaces of the thin wafer W₂ at one time, the cost of process can be decreased. And due to the decreasing of the number of change of sticking process, the breakdown probability of the thin wafer W₂ can be decreased, thereby the yield rate thereof being improved.

In addition, in the present embodiment, since the holing member 104 is formed in a ring shape, it is possible to supply a fluid to the rear surface of the thin wafer W₂ through the through hole 111 and treat them, and also to easily stick the resist 113 on the rear surface of the thin wafer W₂. Further, by using lithographic technique the pattering of the resist 113 stuck on the rear surface of the thin wafer W₂ can be conducted.

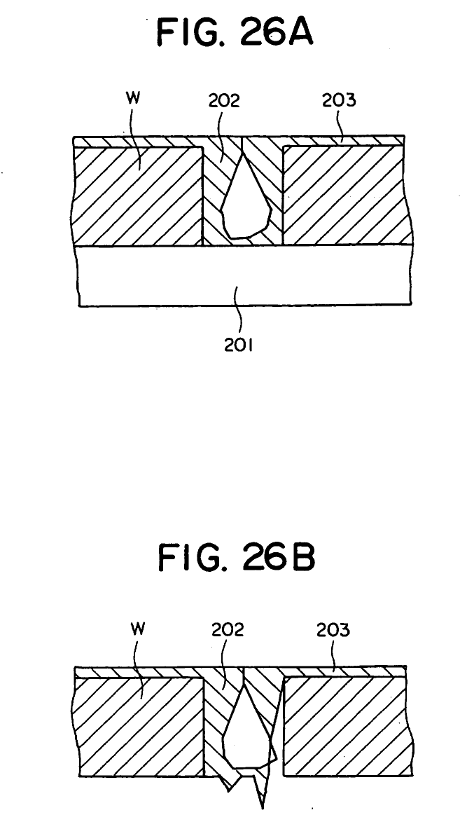

In the present embodiment, in the state of fixing the thin wafer W₂ to the holding member 104, the rear surface of the thin wafer W₂ is opened. Thus, the accuracy of treating can be improved. For example, we described an example of forming of wiring on both surfaces of the thin wafer W₂ by electrolysis plating. However, in case of forming a wiring by such electrolysis plating, as shown in FIG. 26A, when a holding member 201 is stuck on the rear surface of a thin wafer W, since the holding member 201 is at the rear surface of the thin wafer W, one end of a through hole 202 is closed, thereby the plating liquid being remained in the through hole 202. As the result, since the plating 203 is primarily carried out on the entrance of the through hole 202, the through hole 202 can not be filled, thereby large voids being occurred in the through hole 202. In addition, when the thin wafer W is separated from the holding member 201, as shown in FIG. 26B, a plating layer at the bottom surface of the through hole 202, is derived.

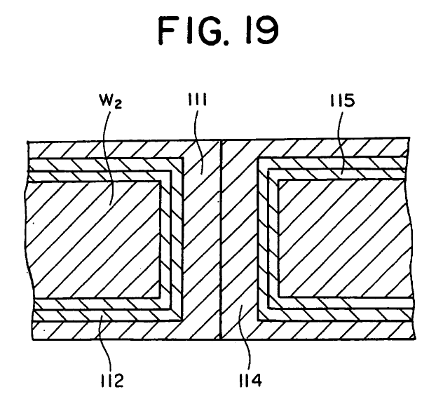

In contrast, in the present embodiment, since the rear surface of the thin wafer W₂ is opened, as shown in FIG. 19, the wiring layer 114 can be completely filled in the through hole 111, thereby the voids being decreased. No. 115 in FIG. 19 denotes an insulation layer.

In the present embodiment, since a length d1 of the adhesive layer 103 in a vertical direction to the peripheral portion of the thin wafer W₂ is larger than a length d2 in a thickness direction of the adhesive layer 103, it is possible to a contact area with the thin wafer W₂, and to improve the reliability of bonding.

In the present embodiment, since an inner peripheral side of the holding member 104 and an end portion of the thin wafer W₂ are chamfered, the break down of the thin wafer W₂ due to the stress concentration can be suppressed. In addition, instead of chamfering, the forming of curved surface is also effective. In this case, similar effects can be obtained.

In the present embodiment, since the surface roughness on the rear surface of the thin wafer W₂ is one-fourth or les the thickness of the adhesive layer 103, the break down of the thin wafer W₂ which is produced when fixing the thin wafer W₂ to the holding member 104 can be suppressed. That is, there is a chance that unevenness is remained on the rear surface of the thin wafer W₂. On the other hand, when the thin wafer W₂ is fixed to the holding member 104, if a thickness of adhesive layer 103 is thin, the whole adhesive layer 103 is entered in the recess portion being on the rear surface of the thin wafer member W₂, because the adhesive layer 103 is pressed against to the thin wafer W₂. As the result, since a protrusion portion at the rear surface of the thin wafer W₂ is contacted with the holding member 104, there is a chance of break down of the thin wafer W₂. In contrast, in the present embodiment, since the surface roughness on the rear surface of the thin wafer W₂ is one-fourth or les the thickness of the adhesive layer 103, even if the thin wafer W₂ is pressed to the adhesive layer 103, it is possible that the adhesive layer 103 between the protrusion portion at the rear surface of the thin wafer W₂ and the holding member 104 is remained. Thereby, the break down of the thin wafer W₂ can be suppressed.

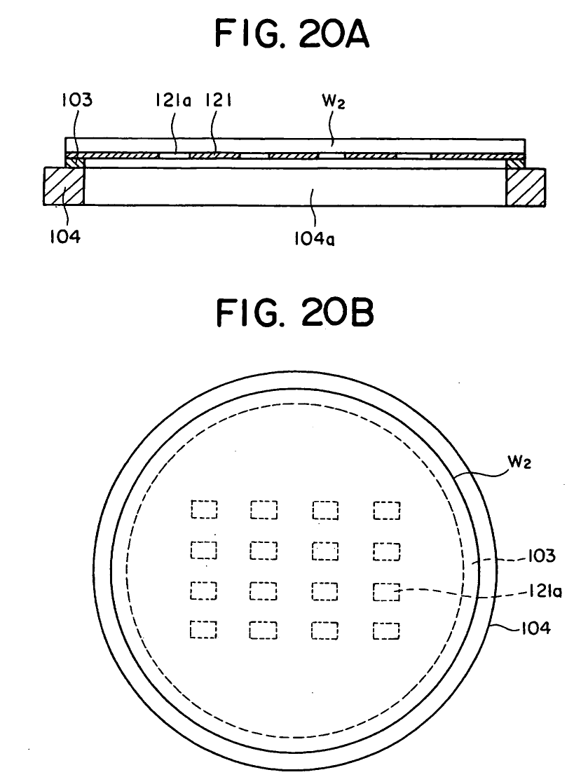

Hereinafter, the fourth embodiments of the present invention will be explained. In the fourth embodiment, an example of bonding a reinforcement plate on a rear surface of a thin wafer will be explained. FIG. 20A and FIG. 20B are a schematic cross sectional view and a schematic plane view of a holding member being in a state of fixing a thin wafer according to the present embodiment, respectively.

As shown in FIG. 20A and FIG. 20B, a reinforcement plate 121 is bonded on a rear surface of a thin wafer W₂. The reinforcement plate 121 is formed in the same shape as that of the thin wafer W₂. The reinforcement plate 121 has an opening 121a at a portion which is necessary to be opened when treating the rear surface of the thin wafer W₂. Through the opening 121a, a fluid such as a chemical liquid, gas, or the like necessary to treat the thin wafer W₂ contacts to the rear surface of the thin wafer W₂.

In the present embodiment, since the reinforcement plate 121 is bonded on the rear surface of the thin wafer W₂, it is possible to use a holding member 104 having a small width. Namely, the width of the holding member 104, when the warp of the thin wafer W₂ due to the stress applied to the thin wafer W₂ is reformed, must be designed such that the stress produced at the end portion at the adhesive layer 103 side of the holding member 104 or at the outer peripheral portion of the thin wafer W₂ is fully small compared with the break down stress of the thin wafer W. Therefore, it is not desirable that the width of the holding member 104 becomes large. In the present embodiment, since the reinforcement plate 121 is bonded on the rear surface of the thin wafer W₂, even if a holding member 104 having a small width is used, it is possible that the stress produced at the end portion at the adhesive layer 103 side of the holding member 104 or at the outer peripheral portion of the thin wafer W₂ is fully small compared with the break down stress of the thin wafer W₂. Thereby, it is possible to use a holding member 104 having a small width. Since the opening 121a is formed in the reinforcement plate 121, the reinforcement plate 121 has not a harmful influence when the treatment is carried to the rear surface of the thin wafer W₂.

Further, similar effects can be obtained by using a film which is formed by coating on the rear surface of the thin wafer W₂ instead of the reinforcement plate 121. The film provides an opening in the necessary portion, where the rear surface of the thin wafer W₂ is opened, when treating the rear surface of the thin wafer W₂ similar with the reinforcement plate 121.

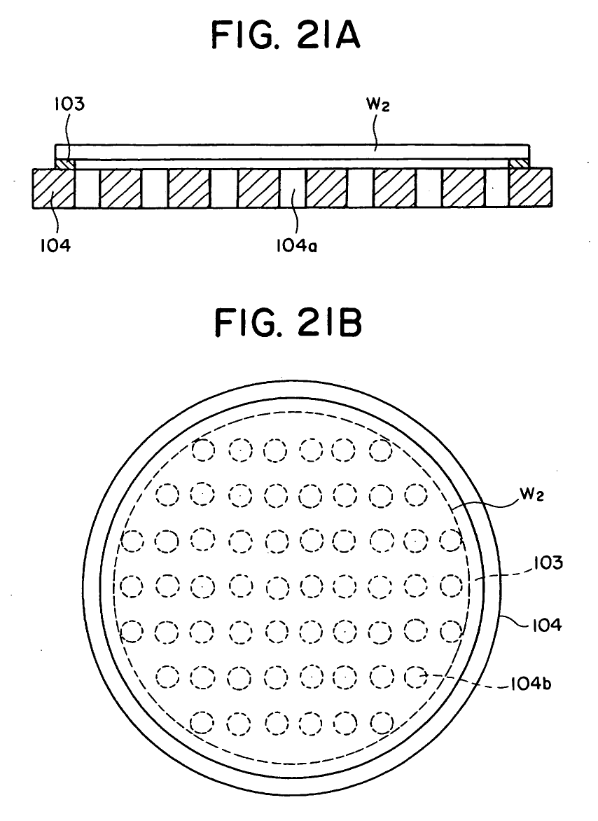

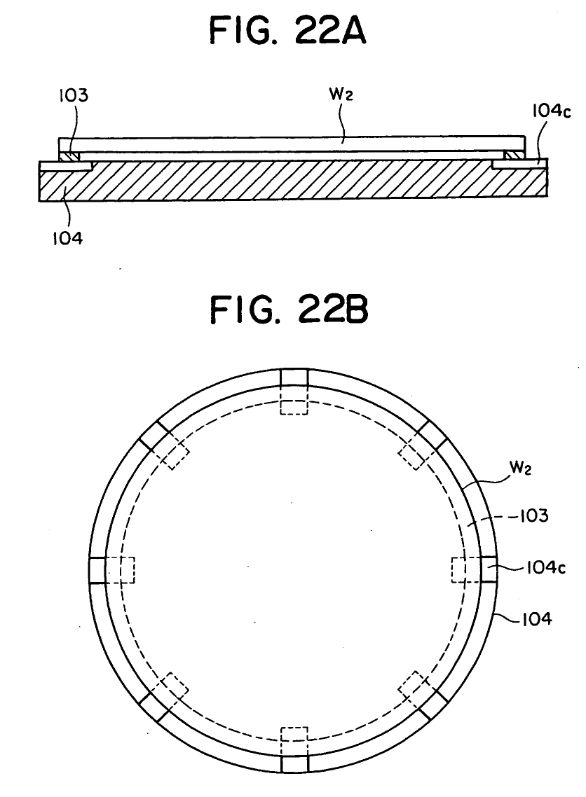

Hereinafter, the fifth embodiments of the present invention will be explained. In the embodiment, an example of using a holding member formed in a disk shape will be explained. FIG. 21A and FIG. 21B are a schematic vertical cross sectional view and a schematic plane view of a holding member being in a state of fixing a thin wafer according to the present embodiment, respectively. FIG. 22A and FIG. 22B are another schematic cross sectional view and another schematic plane view of a holding member being in a state of fixing a thin wafer according to the present embodiment, respectively.

As shown in FIG. 21A and FIG. 21B, a holding member 104 is formed in a shape of disk. In FIG. 21A and FIG. 21B, the holding member 104 has a plurality of openings 104b communicated to the space between a thin wafer W₂ and the holding member 104, at a portion inside of an adhesive layer 103. Further, in FIG. 22A and FIG. 22B, the holding member 104 has a plurality of opening 104c communicated to the space between the thin wafer W₂ and the holding member 104, at a surface of the holding member 104 and from the outside portion of the adhesive layer 103 to the inside portion of the adhesive layer 103. That is, the opening 104c is provided to pass the adhesive layer 103.

In the present embodiment, the holding member 104 is formed in a shape of disk, and the opening 104b, 104c is formed n the holding member 104. Thus, the effects similar with the third embodiment can be obtained. In the embodiment, the holding member 104 is formed in a shape of disk, other shape having no disk shape is allowed. Further, in case of providing an adhesive layer 103 as shown in FIG. 15, it is unnecessary to form an opening 104b, 104c in the holding member 104. In this case, an opening formed between adhesive layers 103 has the same function as the opening 104b, 104c.

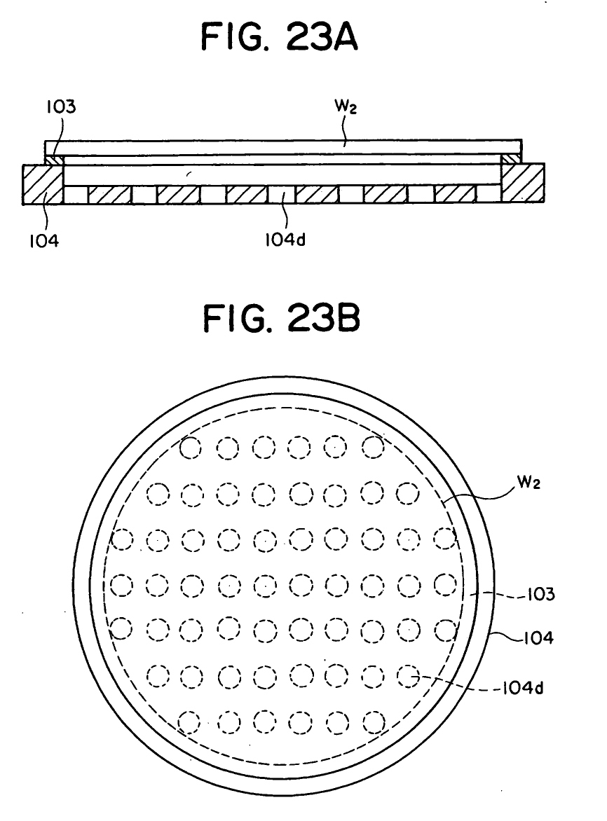

Next, the sixth embodiments of the present invention will be explained. In the present embodiment, an example of using a holding member in which a step is formed at a peripheral portion and an inside portion thereof facing a thin wafer W₂ will be explained. FIG. 23A and FIG. 23B are a schematic cross sectional view and a schematic plane view of a holding member being in a state of fixing a thin wafer W₂ according to the present embodiment, respectively.

As shown in FIG. 23A and FIG. 23B, in the holding member 104, between the peripheral portion thereof and a portion inside of the holding member 104 and facing the thin wafer W₂, the step is formed. Concretely, an upper surface of the inside portion of the holding member 104 facing the thin wafer W₂ is lower than an upper surface of the peripheral portion of the holding member 104. Further, in the holding member 104, a plurality of openings 104d communicated to a space between the thin wafer W₂ and the holding member 104 are formed at a position inside of the adhesive layer 103.

In the embodiment, since the upper surface of inside portion of the holding member 104 facing the thin wafer W₂ is lowered from the upper surface of the peripheral portion of the holding member 104, the contact of the thin wafer W₂ with the holding member 104 can be securely suppressed. That is, when a space between the thin wafer W₂ and the holding member 104 is small, there is a possibility of contacting of the thin wafer W₂ to the holding member 104. In contrast, in the present embodiment, since an upper surface of inside portion of the holding member 104 facing the thin wafer W₂ is lowered from an upper surface of peripheral portion of the holding member 104, a space between the thin wafer W₂ and the holding member is large, thereby the above problem being suppressed.

In the embodiment, since the openings 104d are formed, effects similar to the third embodiment can be obtained. In the present embodiment, although the openings 104d is formed in the holding member 104, as shown in FIG. 15, when an adhesive layer 103 is provided, there is no necessary to form an opening 104d in the holding member 104. Also, similar to the opening 104c shown in FIG. 22A and FIG. 22B, the opening can be formed to pass the adhesive layer 103.

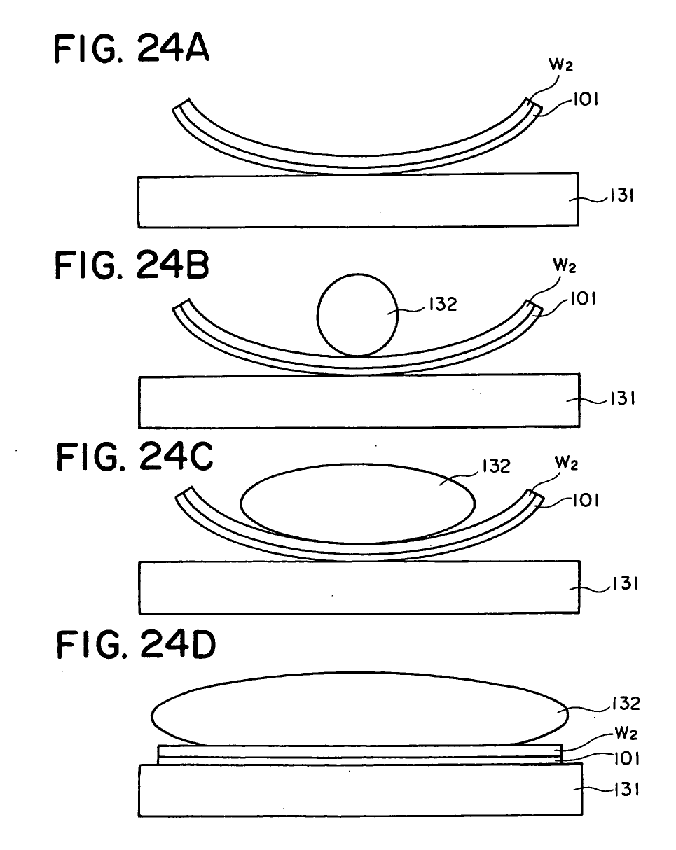

Next, the seventh embodiments of the present invention will be explained. In the embodiment, an example with respect to the flattening a thin wafer by inflating a balloon will be explained. FIG. 24A to FIG. 24D are schematic views showing the holding process of thin wafer of the present embodiment.

In the third embodiment, after thinning a wafer W₁, without releasing the adsorption by a vacuum chuck, a holding member 104 is mounted to a thin wafer W₂. However, in case of using other device, the thinning process of a wafer and the holding process of the thin wafer W₂ are separately conducted in a different place. In this case, when the adsorption by the vacuum chuck is released, there is the possibility that the thin wafer W₂ is warped by internal stress. At this time, when the wafer W₂ is disposed on a stage 131 for holing to the holding member 104, as shown in FIG. 24A, the thin wafer W₂ is in a warped state. In this state, when the flattening of the thin wafer W₂ is enforced, there is the high possibility of break down, because a stress is locally applied to the thin wafer W₂.

Accordingly, as shown in FIG. 24B, a balloon 132 formed of an elastic material is disposed on a center of the thin wafer W₂ or the warped portion thereof. And the balloon 132 is inflated along the warped portion, as shown in FIG. 24C. And finally, as shown in FIG. 24D, until the peripheral portion of the thin wafer W₂ is contacted with the stage 131 through a protective film 101, the balloon 132 is inflated to flatten the thin wafer W₂. Thereafter, according to the process like as the process shown in FIG. 13C to FIG. 13E, the thin wafer W₂ is attached to the holding member 104.

In the present embodiment, since the embodiment are processed by disposing the balloon 132 on the center of the thin wafer W₂ or on the center of the warped portion of the thin wafer W₂, inflating the balloon 132, and reforming the warp of the thin wafer W₂, it is possible to flatten the thin wafer W₂ while suppressing the cracking of the thin wafer W₂.

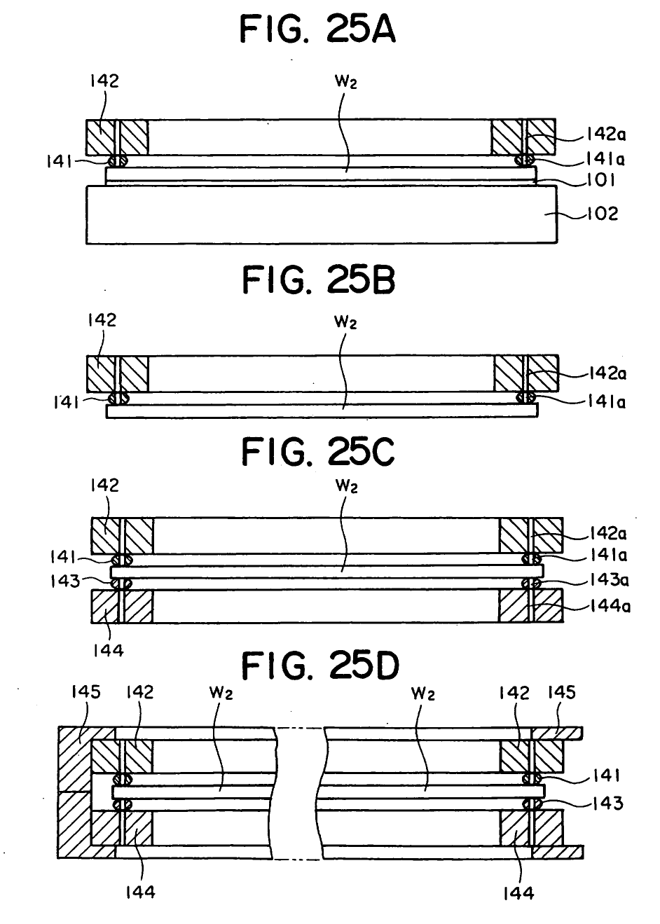

Next, the eighth embodiments of the present invention will be explained. In the present embodiment, an example that a thin wafer is attached to a chilled holding member will be explained. FIG. 25A to FIG. 25D are schematic views showing the holing process of thin wafer of the present embodiment.

As shown in FIG. 25A, in a state that the thin wafer W₂ is adsorbed on a stage 102 at a room temperature, the holding member 142 is attached to the rear surface of the thin wafer W₂ through a ring shaped contacting layer 141. The holding member 142 has a similar structure as the holding member 104, but in the contact layer 141 and the holding member 142, respective holes 141a, 142a for applying the vacuum are formed. By applying the vacuum through the respective holes 141a, 142a, the thin wafer W₂ is attached to the holding member 142 through the contact layer 141.

Thereafter, the holding of the thin wafer W₂ to the stage 102 by the vacuum chuck is released. Thereby, the thin wafer W₂ is adsorbed by vacuum to the holding member 142, and as shown in FIG. 25B, the thin wafer W₂ is held on the holding member 142. After that the protective film 101 is removed.

Subsequently, as shown in FIG. 25C, in this state, the holding member 144 maintained at a lower temperature lower than a room temperature or a processing temperature, for example, at a temperature of −50° C. is attached to the surface of the thin wafer W₂ through the contact layer 143. The contact layer 143 and the holding member 144 have the same structure as the contact layer 141 and the holding member 142, respectively. That is, to the contact layer 143 and holding member 144, holes 143a and 144a for applying a vacuum are respectively provided, by applying a vacuum through the holes 143a and 144a, the thin wafer W₂ is attached to the holding member 144 through the contact layer 143.

The contact layer 141, 143 is formed of a material which has an elastic deformation ability at a cooling temperature, at a room temperature and at a processing temperature. As such material, for example, a rubber material and the other resin material are examplified. A length of the contact layer 141, 143 in a direction vertical to the periphery of the thin wafer W₂ is larger than a length of the contact layer 141, 143 in a direction of thickness thereof.

After the thin wafer W₂ is attached to the holding member 144, a temperature of the holding member 144 is returned to a room temperature or a processing temperature. Thereafter, as shown in FIG. 25D, the holding member 142, 144 is held between ring shaped fixing member 145 by using mechanical or magnetic force. In FIG. 25D, the left hand view indicates an example of holding the holding member 142, 144 by using a mechanical force and the right hand view indicates an example of holding the holding member 142, 144 by using magnetic force.

In the present embodiment, the thin wafer W₂ is attached to the holding member 144 which is held at a low temperature lower than a room temperature, and, at that situation, the temperature of the holding member 144 is returned to a room temperature. Therefore, by the expansion of the holding member 144, uniform tensile stress can be applied to the thin wafer W₂ through the contact layer 143. Thereby, the film stress of the thin W₂ and the warp due to the self weight can be decreased.

When the holding member 144 is constituted of Si, it is possible to give a tensile stress to the thin wafer W₂ at any temperature. Further, when the holding member 144 is formed of material having a line expansion coefficient larger than that of Si, the tensile stress applied to the thin wafer W₂ is increased with the increasing of temperature. Here, if the tensile stress is much large, there is the possibility of progress of cracking break from a chipping at the periphery of the thin wafer W₂. In contrast, when the holding member is made of a material having a small line expansion coefficient smaller than that of Si, the tensile stress applied to the thin wafer W₂ is decreased with the increasing of temperature. Here, if this tensile stress is much small, the warp of the thin wafer W₂ is decreased, but it is impossible to obtain the flat thin wafer W₂. Therefore, based on the requirement of processing temperature, a constituting material of the holding member 144 having a proper line expansion coefficient and a temperature of the holding member 144 must be selected.

In the present embodiment, the contact layer 143 is used, but the similar effect can be obtained by use of an adhesive layer 103 instead of the use of the contact layer 143. Further, in the embodiment, a temperature at the time of attaching the thin wafer W₂ to the holding member 142 is a room temperature, but similar to the holding member 144, it is allowed to maintain the thin wafer W₂ at a low temperature lower than a room temperature or a processing temperature, and to attach the thin wafer W₂ in that state.

The present invention is not limited by the above embodiments, a structure, material property, and disposition of every member can be changed in the scope of the invention. For example, the invention can be applied to a SOI, a compound semiconductor such as GaAs and the like. Further, the present invention is effective for holding method of a thin film material, not to be limited to the semiconductor substrate.

What is claimed is:

1. A wafer supporting plate for supporting a semiconductor wafer thereon, the semiconductor wafer comprising:
a through hole passing through front and rear surfaces thereof; and
an electrode for forming an element formed on the front surface of the semiconductor wafer and extended to the rear surface of the semiconductor wafer,
wherein the wafer supporting plate comprises an opening passing through between a front surface and rear surface of the wafer supporting plate, the opening being disposed to face a region including at least one or more of the through hole of the semiconductor wafer and a cross sectional area of the opening being larger than that of the through hole of the semiconductor wafer.

2. A wafer supporting plate according to claim 1, further comprising an alignment mark for aligning a position of the semiconductor wafer.

3. A wafer supporting plate for supporting a semiconductor wafer thereon, the semiconductor wafer comprising:
a through hole passing through front and rear surfaces of the semiconductor wafer; and
an electrode formed on the front surface of the semiconductor wafer and extended to the rear surface of the semiconductor wafer,
wherein the wafer supporting plate comprises a recess portion at a side of supporting the semiconductor wafer, the recess portion being disposed to face a region including at least one or more of the through hole of the semiconductor wafer and an opening area of the recess portion being larger than a cross sectional area of the through hole of the semiconductor wafer.

4. A wafer supporting plate according to claim 3, wherein a part of the recess portion passes through both surfaces of the wafer supporting plate.

5. A wafer supporting plate according to claim 3, further comprising an alignment mark for aligning a position of the semiconductor wafer.

6. A manufacturing method of a semiconductor device using the wafer supporting plate according to claim 1,
the method comprising supporting the semiconductor wafer and processing at least a portion of the through hole.

7. A manufacturing method of a semiconductor device using the wafer supporting plate according to claim 3,
the method comprising supporting the semiconductor wafer and processing at least a portion of the through hole.

8. A method of holding a thin wafer to a holding member comprising:
bonding the thin wafer to the holding member through an adhesive layer provided along a periphery of the thin wafer; and
fixing the thin wafer to the holding member,
wherein at least one of the holding member and the adhesive layer has an opening communicated to a space between the thin wafer and the holding member.

9. A method of holding a thin wafer according to claim 8,
wherein the holding member is formed in a shape of ring and an inner peripheral portion of the holding member and an end portion of the thin wafer are chamfered, or formed with a curved surface.

10. A method of holding a thin wafer according to claim 8,
wherein a length of the adhesive layer in a direction vertical to the periphery of the thin wafer is larger than a length of the adhesive layer in a thickness direction.

11. A method of holding a thin wafer according to claim 8, further comprising:
contacting a balloon formed of an elastic material to the thin wafer;
inflating the balloon to reform a warp of the thin wafer; and
fixing the thin wafer to the holding member.

12. A method of manufacturing a semiconductor device using a method of holding a thin wafer according to claim 8,
wherein the front and rear surfaces of the thin wafer are treated in a state of fixing the thin wafer to the holding member.
